(19) United States
(12) Patent Application Publication
(10) Pub. No.: US 2008/0117448 A1
(43) Pub. Date: May 22, 2008

(54) TEMPLATE-BASED ART CREATION AND INFORMATION MANAGEMENT SYSTEM FOR ADVERTISING

(75) Inventors: Scott K. Ijams, Trabuco Canyon, CA (US); Milton S. Allione, Santa Ana, CA (US); Richard T. Hocking, Aliso Viejo, CA (US); Darren A. Lott, Orange, CA (US)

Correspondence Address: MCCORMICK, PAULDING & HUBER LLP, CITY PLACE II, 185 ASYLUM STREET, HARTFORD, CT, 06103, US

(73) Assignee: MONEY MAILER, LLC, GARDEN GROVE, CA (US)

(21) Appl. No.: 11/560,915

(22) Filed: Nov. 17, 2006

(51) Int. Cl. G06F 9/44

(52) U.S. Cl. 358/1.15

(57) ABSTRACT

A template-based art creation system is used for the real-time creation of advertising art images, resulting in an automatically created, high resolution, pre-press ready art file for use in directly creating printing plates for commercial printing presses. The system includes a server module and client module. At the client module, a user creates and/or modifies a simulated advertising template, which includes a low-resolution background image for a particular type of advertisement (e.g., based on business type) and rendering data specifying where text and graphic elements are placed with respect to the background image. The user customizes the template by adding, positioning, and formatting text and graphic elements over the background image. Subsequently, information relating to the customized template is transmitted to the server module, which produces the pre-press ready art file. The file is a high-resolution equivalent of the low-resolution customized template as prepared by the user via the client module.

### FIELD OF THE INVENTION

The present invention relates to data processing and, more particularly, to document presentation processing.

### BACKGROUND OF THE INVENTION

For selling direct mail advertising, it is typically the case that a sales representative will meet with a prospective advertiser to “pitch” the general idea of a direct mail advertisement insert, e.g., a coupon in a grouping or packet of coupons sent to consumers by mail in a particular geographic area. Although examples of the types of ads used by other advertisers might be available, there is no practical, cost-effective way to provide a specifically tailored example of what the ad will look like for the particular prospective advertiser. Thus, prospective advertisers are asked to purchase an ad insert or the like, but without visual reference to the ad itself. Without such specific examples, the sales process is made less intuitive and more difficult.

Moreover, once a prospective advertiser/client decides to proceed with an advertisement, there is usually a significant delay before the ad is finally ready for mailing or other use. In particular, preparing advertisements or other graphic-intensive documents for use in direct mail promotional materials, magazine or newspaper publications, or the like is a time- and labor-intensive process. For example, it may involve consulting with graphics designers and advertising executives, the selection of graphic elements and layouts, the review, modification, and proofing of draft materials (perhaps through several iterations), and converting the finalized layout to a form suitable for use in preparing printing plates. Because of this time delay, it is difficult for advertisers to advertise on “short notice,” e.g., to take advantage of local or changing events where little advance notice is available. Additionally, the “disconnected” nature of the sales and art production process requires more time of both the sales representative and advertiser, who may have to meet several times to go over the advertising artwork. For those who advertise frequently, the cumulative time spent on this process can be considerable, especially if ads are frequently changed or modified.

### SUMMARY OF THE INVENTION

An embodiment of the present invention relates to a system for creating advertisements or other art images. The system includes a user interface and a control module configured for disconnected coordinated operation. (That is, although the user interface and control module are configured for independent operation, e.g., on different computer terminals at different locations, they may be directed to communicate with one another for data transfer and other operations.) The user interface is configured for user creation and/or modification of a computer-simulated advertising piece or other art image. This simulation includes a background image and rendering data that specifies the appearance and location of text and/or graphic elements (e.g., drawings or pictures) with respect to the advertisement's form factor (e.g., size/dimensions and layout). For example, the rendering data may be based on an X-Y coordinate system with a defined point of origin. The control module is configured to automatically generate press data based on the background image, text and/or image elements, and rendering data created by/through the user interface. By “press data,” it is meant data (e.g., a high resolution art file) that can be used in creating a printing plate for printing commercial quality advertisements corresponding to the advertisement simulated on the user interface.

In another embodiment, a template-based art creation and information management system for advertising allows for the real-time creation and manipulation of simulated advertising (or other) art images in a distributed and disconnect environment, resulting in an automatically-created, high-resolution, pre-press ready art file for use in directly creating printing plates for commercial printing presses. The system includes a server module in place on a server computer/terminal, and a client module running on one or more remote client terminals. The server module and client module(s) are configured for communicating with one another over a communications network such as an IP/packet data network (e.g., the Internet) or a public switched telephone network. The server module may include a number of public and client-specific art libraries, a high-resolution source library, and a control module with a digital processing engine. The client module includes a rendering engine and a user interface. Both modules may include one or more software applications, scripts, subroutines, or other programs, operating either alone or in conjunction with one another, which may be implemented across one or more computer terminals and/or other electronic devices.

The client module is provided with one or more low-resolution, fixed art images and one or more graphic elements. Each fixed art image is a generic or client-specific image relevant to a type or category of advertisement, for use as a background image (or the like) as part of a customized advertisement. For example, one available art image might be intended for use as the background of a pizza restaurant advertisement. (This also encompasses “blank” or “white” backgrounds of a particular size and/or shape.) The graphic elements are “clip art”-like drawings or pictures suitable for augmenting the background art image. (The background images and graphic elements are occasionally referred to collectively herein as “advertisement image elements.”) A fixed art image in combination with (i) font/text content and/or graphic elements and (ii) rendering data (which specifies the appearance and location of the font and graphic elements with respect to the fixed art image) is referred to as a “simulated template,” e.g., an electronic simulation of an advertisement template. (The simulated template may include the actual data/files for the fixed art image and graphic elements, or identifiers that identify these elements, e.g., file names.) In operation, a user such as a sales representative and/or advertiser accesses the client module by way of the user interface to create and/or modify a simulated template. Typically, this will be done at a location remote from the server module, with the client module and server module being disconnected from one another. To create a simulated template “from scratch,” if this function is made available to the user, the user selects a background image and overlays text and/or selected graphic elements on the background art image, according to a desired advertisement layout. In particular, using the client module, the user may manipulate the size, color, and location of text and graphic elements and the content of text. The client module renders/displays the text and graphic elements (e.g., on a monitor or other electronic display of the terminal running the client module) such that their appearance, size, color, transparency, and location nearly perfectly correspond to how the final pre-press ready art file will appear once created by the server module digital processing engine, using high-resolution graphic components and fonts. Based on the selected background image and on the format and placement of text and/or graphic elements with respect to the background image, the client module generates rendering data for the simulated template. (The rendering data may be generated once the layout is complete, or concurrently with the placement and/or positioning of text and graphic elements.)

To customize or change an existing simulated template, the simulated template is accessed and displayed through the user interface. For example, the background art image is displayed, and any text and/or graphic element portions of the template are displayed in relation to the background image according to the rendering data. Using the functionality provided by the user interface, the placement and appearance of existing text and/or graphic elements can be modified based on a desired advertisement layout. Additionally, text and/or graphic elements may be added to or deleted from the background image. Based upon the modifications, the client module modifies or re-generates the rendering data correspondingly.

Once customization of a simulated template is complete (e.g., once a new template is created or an existing template is customized/modified), a temporary communication link is established between the client module and the server module. Information relating to the customized template (“customization information”) is transmitted from the client module to the server module. The digital processing engine on the server module uses the customization information to produce a pre-press ready art file corresponding to the customized template. In particular, the customization information may include the identity of the background art image, the identities of any graphic elements used in the template, and the rendering data specifying the appearance and location of font and graphic elements with respect to the background image. High-resolution equivalents of the background image and graphic elements are stored in the high-resolution source library on the server module. To produce the pre-press ready art file, the customization information is used as a “recipe,” with the digital processing engine applying the rendering data to the high-resolution equivalents of the background image and graphic elements identified in the customization information. Thus, the pre-press ready art file is a high-resolution equivalent of the low-resolution customized template as prepared by the user. Advertisement inserts printed from a printing plate produced using the pre-press ready art file correspond to the user's customized template directly, meaning that the turnaround for creating print-ready advertisements is greatly reduced, to several minutes instead of several days.

The art creation system allows a user to simulate the creation and/or modification of an electronic advertising art image while disconnected from the network and server module. After the customized simulated template is complete and the client module is re-connected to the network, the client module can request a high-resolution art proof from the server-based digital processing engine. The digital processing engine creates a high-resolution, pre-press ready graphics art file from the customization information received from the client module. On the client side, the simulation involves user manipulation of text/fonts and graphic elements, and the precise, computer-controlled display of these components, optionally over a background art image in a WYSIWYG edit mode. On the server side, the variable components (e.g., text and graphic elements) are mapped to a corresponding high-resolution graphic arts layout that is maintained and automatically manipulated on the remote server based upon the customization information (e.g., size, color, and location information of each component) received from the client module.

### BRIEF DESCRIPTION OF THE DRAWINGS

The present invention will be better understood from reading the following description of non-limiting embodiments, with reference to the attached drawings, wherein below:

FIG. 1 is a schematic diagram of a template-based art creation and information management system according to an embodiment of the present invention;

FIGS. 2A and 2B are schematic diagrams of a client module portion of the system;

FIG. 3 is a schematic diagram of a server module portion of the system;

FIG. 4 is a schematic diagram of a template background image;

FIGS. 5A and 5B are schematic diagrams of a simulated advertisement template;

FIG. 6A is a schematic diagram of a menu showing categories of businesses for which simulated templates are available;

FIG. 6B is a schematic diagram of a selection of available templates for a particular type or category of business;

FIGS. 7A and 7B are schematic diagrams of graphic elements;

FIGS. 8, 9A, and 9B are schematic diagrams of a modified or customized simulated advertising template;

FIG. 10A is a flowchart illustrating the steps of a method for creating a pre-press ready art file from a customized simulated template;

FIGS. 10B and 10C are schematic diagrams of processes for creating the pre-press ready art file;

FIGS. 11A and 11B are schematic diagrams of one embodiment of an information and advertisement management portion of the system; and

FIG. 12 is a schematic diagram of an alternative embodiment of the art/advertisement creation system.

### DETAILED DESCRIPTION

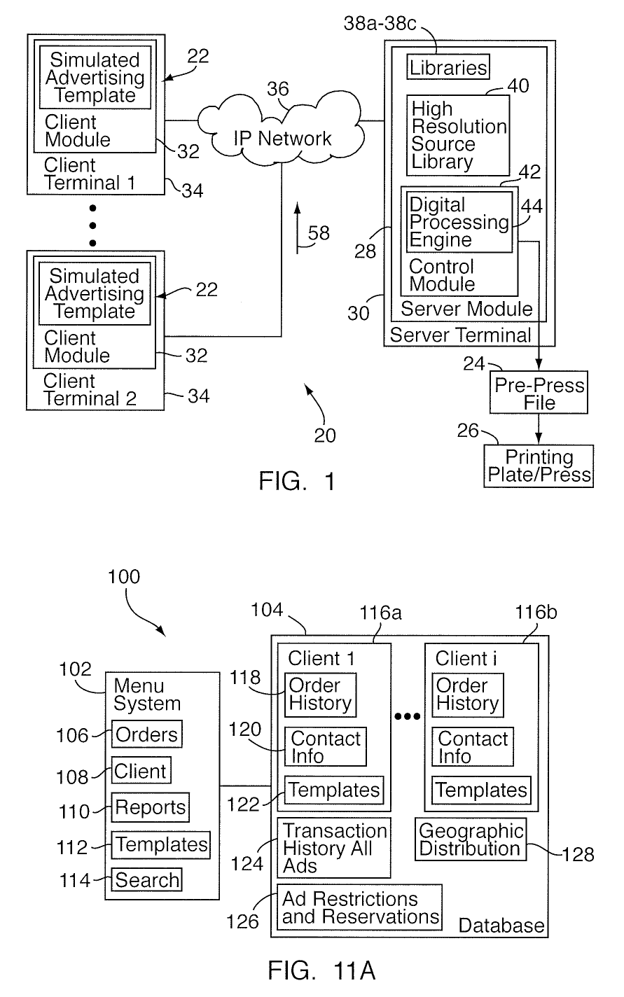

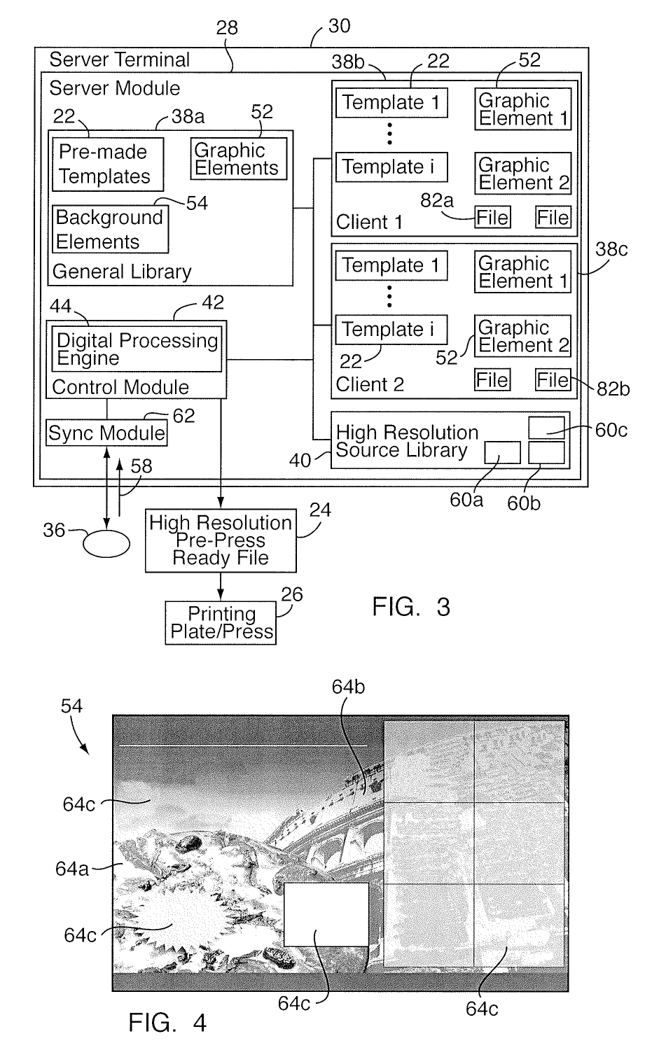

With reference to FIGS. 1-10C, a template-based art creation and information management system for advertising 20 allows for the real-time creation and manipulation of simulated advertising (or other) templates 22 in a distributed and disconnect environment, resulting in an automatically-created, high-resolution, pre-press ready art file 24 for use in directly creating printing plates for commercial printing presses 26. The system 20 includes a server module 28 in place on one or more server computers or terminals 30, and a client module 32 running on one or more remote client terminals 34. (Typically, each end user runs a copy of the client module 32 on the user's computer or other terminal; alternatively or in addition, the client module may be a web-based application.) The server module 28 and client module 32 are configured to communicate with one another over a communications network 36 such as an IP/packet data network (e.g., the Internet) or a public switched telephone network. The server module 28 may include a number of public and client-specific art libraries 38a-38c, a high-resolution source library 40, and a control module 42 with a digital processing engine 44. The client module 32 includes a rendering engine 46 and a user interface 48.

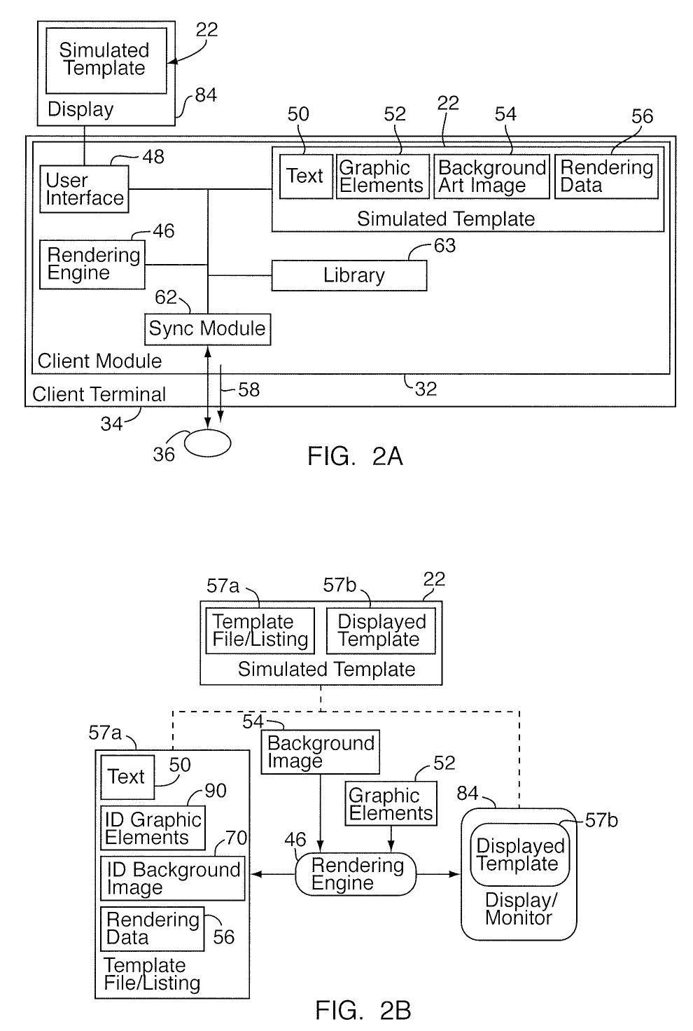

The simulated template 22 includes a fixed, low-resolution, generic or client-specific art image 54 suitable for use as the background for a type or category of advertisement, in combination with (i) font/text content 50 and/or graphic elements 52 and (ii) rendering data 56, which specifies the appearance and location of the font and graphic elements with respect to the fixed art image 54. Unless otherwise specified herein, “simulated template” refers generally to either or both of (i) a template file or other data listing 57a and (ii) a computer display of the template 57b that corresponds to the template listing 57a. The template listing 57a lists and specifies the template contents/elements in a format interpretable by the rendering engine 46. For example, with reference to FIG. 2B, the listing 57a might include text content 50, identifiers 90 associated with one or more graphic elements 52, an identifier 70 associated with a background image 54, and rendering data 56. When the template listing 57a is accessed, the rendering engine 46 reads the template listing 57a and generates the displayed template 57b on a terminal display or monitor 84 in accordance with the contents of the listing 57a. In particular, the rendering engine 46 accesses the background image file and graphic elements listed in the template listing 57a. Based on the rendering data 56 (which specifies formatting, position, etc.), the rendering engine 46 renders/displays the text 50, graphic elements 52, and background image 54 on the monitor 84 such that their appearance, size, color, transparency, and location correspond to how the final pre-press ready art file 24 will appear once created by the server module digital processing engine 44, using high-resolution graphic components and fonts.

In operation, a user (such as a sales representative and/or advertiser) accesses the client module 32 by way of the user interface 48 to create and/or modify a simulated template 22. The user customizes the template 22 by adding one or more graphic elements 52 and/or text 50 to the background art image 54, and/or by modifying existing image elements and text, according to the rendering data 56 for that template and the layout desired by the user for an advertisement using the simulated template 22. The user interface 48 includes various functions/tools for the user to manipulate and modify the displayed template 57b in a GUI-based, WYSIWYG (“what you see is what you get”) manner. Thus, through the user interface 48, the user may manipulate the size, color, and location of text and graphic elements and the text content of the displayed template 57b. Once the desired layout is complete, a communication link is established between the server module and the client module over the network 36, and customization information 58 relating to the template is transmitted to the server module 28. (By “customization information,” it is meant information that at a minimum allows the server module to re-create or re-generate a simulated template as customized by a user.) The digital processing engine 44 on the server module 28 produces a pre-press ready art file 24 by applying the customization information 58 received from the client module to the high-resolution equivalents 60 of the template elements 50, 52, 54 in the high-resolution source library 40. The pre-press ready art file 24 is a high-resolution equivalent of the low-resolution customized template as prepared by the user. Thus, ad inserts printed from a printing plate 26 produced using the pre-press ready art file 24 correspond to the user's customized template directly, meaning that the turnaround time for creating print-ready advertisements is greatly reduced, e.g., a matter of minutes instead of several days.

The art creation system 20 allows a user to simulate the creation and/or modification of an electronic advertising art image while disconnected from the network 36 and server module 28. After the customized simulated template 22 is complete and the client module 32 is re-connected to the network 36, the client module 32 can request a high-resolution art proof from the server-based digital processing engine 44. The digital processing engine 44 creates a high-resolution, pre-press ready graphics art file 24 based on the customization information 58 received from the client module 32. On the client side, the simulation involves user manipulation of text/fonts 50 and graphic elements 52, and the precise, computer-controlled display of these components, optionally over a background art image 54 in a WYSIWYG edit mode. On the server side, the variable components (e.g., text and graphic elements) are mapped to a corresponding high-resolution graphic arts layout that is maintained and automatically manipulated on the remote server based upon the customization information 58 (e.g., size, color, and location information of each component) received from the client module.

The server module 28 is a software program or suite of software programs running on one or more server terminals 30, which may be server-configured computers or other electronic units having standard hardware and/or software for accessing and communicating over the network 36. The server module 28 and client module 32 may each include a synchronization module 62 for coordinated data transfer over the network 36. The system 20 uses the network 36, e.g., the Internet, as the communications link or channel for the synchronization/communication process. For example, the synchronization module 62 may include network contact or identification information of the server and client modules, as applicable, such as IP addresses to which data packets are addressed for sending over the network 36 in a standard manner. The synchronization module may also include a communications program implementing one or more communications protocols for the transmission and reception of data between the client and server modules, and possibly configured for error checking and validating received data, sending acknowledgement messages and other signaling messages, and the like. When data is received at the synchronization module 62, the data is re-formatted if necessary, optionally stored in memory, and routed where appropriate based on the type of data received.

The synchronization module 62 may be differently configured for the server module 28 and client module 32. Also, the synchronization module 62 may be configured in a number of different ways depending on the communication medium connecting the client terminal 34 and server terminal 30 and the underlying communications hardware/software in place on the client and server terminals. For example, the synchronization module could be configured for interfacing with a wireless communications module, or it could be configured for direct, modem-based communication over a circuit-switched telephone network.

In regards to initially generating or creating the simulated templates 22, the system 20 may be configured in several manners. First, the client module 32 may be configured for a user to create a simulated template “from scratch.” Here, the client module 32 is provided with one or more background art images 54 and graphic elements 52. These may be “pre-loaded” on the client terminal as part of the client module software, and/or they may be obtained from the server module 28. In either case, the client module 32 contains a temporary or permanent library 63 of available advertisement image elements. As noted above, the fixed art images 54 are generic or client-specific images relevant to particular types or categories of advertisements, for use as advertisement background images. The graphic elements are “clip art”-like drawings or pictures suitable for augmenting the background art image. To create a simulated template 22, the user selects a background image 54 from among the available background images. For example, the user interface 48 may contain a menu option the selection of which results in the display of the various categories and types of background images available, including thumbnail views of the background images. After selecting a particular background image 54, the image 54 is displayed, and the user may then access the functionality of the user interface 48 to overlay text 50 and/or selected graphic elements 52 on the background art image 54, according to a desired advertisement layout. For example, the user interface 48 includes a text entry and formatting tool (including the ability to select and move text blocks), and a function for selecting, formatting, placing, and moving graphic elements, in a WYSIWYG manner. Based on the selected background image and on the format and placement of text and/or graphic elements with respect to the background image, the client module generates the template listing 57a and rendering data 56 for the simulated template 22.

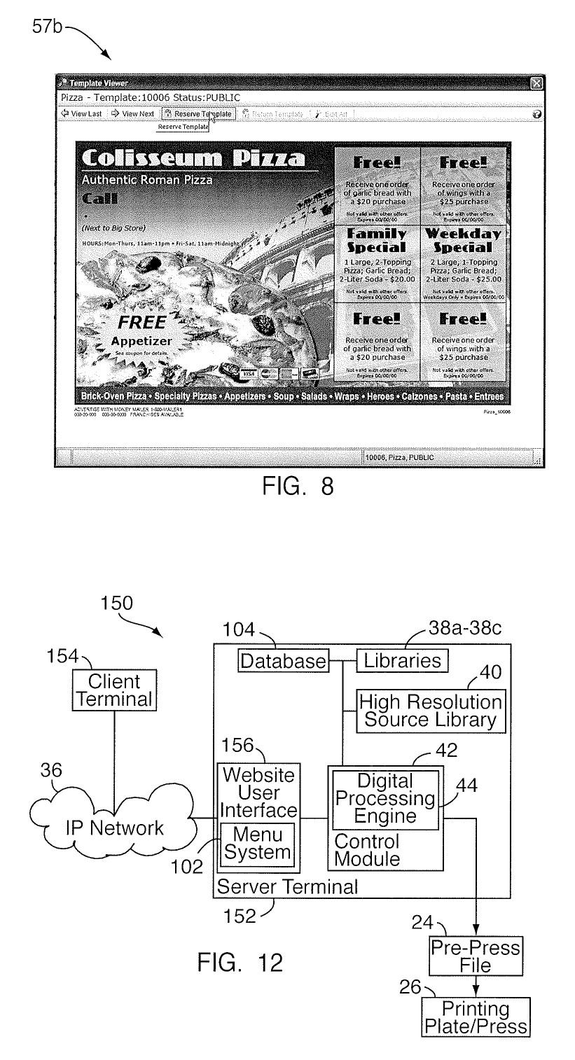

Instead of users creating simulated templates by combining elements from a library 63, or possibly in addition to such a function, the system 20 may include “pre-made” simulated templates 22. Pre-made templates are provided to the user in the form of one or more associated files containing: a fixed background or other art image 54 appropriate for a particular type of advertisement; one or more graphic elements 52 tailored for use with the background image 54; and rendering data 56 specifying the positioning, etc. of the text and graphic elements with respect to the background image 54. Pre-made templates may also include pre-positioned and/or pre-formatted sample text 50 (e.g., as shown in FIG. 8), used for indicating the locations of text boxes (if any) and for providing pre-formatted text according to the template motif. In other words, the sample text may be pre-formatted with a particular font, size, color, and style according to the overall artistic character of the template, to provide a “starting point” for the user in customizing the template. Pre-made templates may be provided as part of the client module library 63, and/or they may be obtained from the server module 28. In operation, a user selects a pre-made simulated template of interest, by reviewing the pre-made templates 22 available on the client module 32. The rendering engine 46 displays the elements of the selected pre-made template 22 according to the listing 57a and rendering data 56 of the selected template. The user then customizes the pre-existing text and graphic elements (or adds or removes text and graphic elements) according to a desired layout. As should be appreciated, the use of pre-made templates may facilitate template customization, since template elements are pre-selected and pre-configured and the user does not have to select from among all possible elements. Advertising professionals or graphic artists may be employed to design the layouts of the pre-made simulated templates 22, thereby providing professional-quality simulated templates that any user can easily customize.

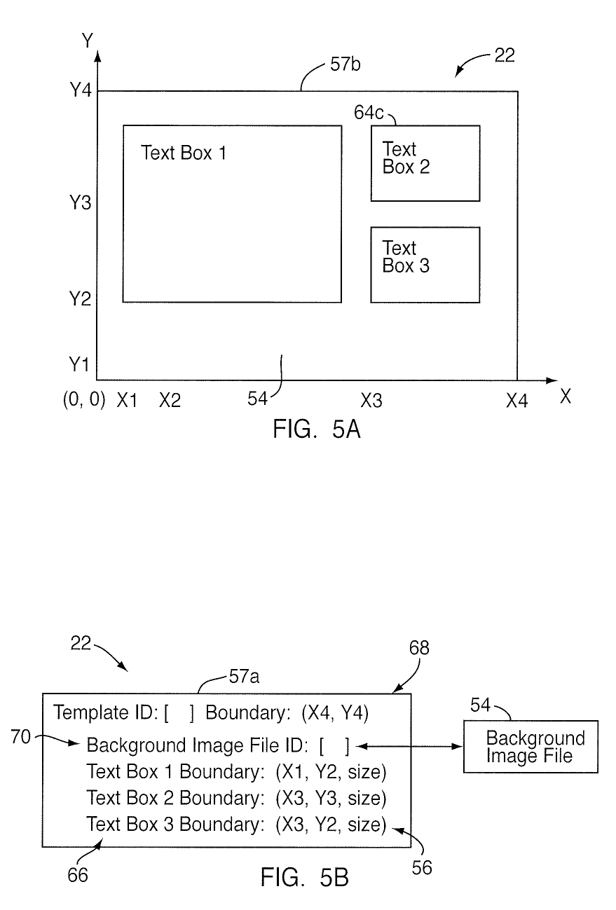

FIGS. 5A and 5B show an example of one possible format for pre-made simulated templates 22. Here, FIG. 5B shows a data file or other listing 57a of the template, and FIG. 5A shows a graphic representation 57b of the template listing 57a. As indicated, the simulated template 22 includes a background art image 54 and rendering data 56. The rendering data 56 specifies the positions and/or formatting of various elements with respect to the background image, such as graphic elements 52, text 50, and text boxes 64c superimposed on the background image. (A text box is simply a designated area for placing text. Text boxes may be part of the background image, provided as simple graphic elements, or provided as graphic elements with associated text entry functionality, e.g., “clicking on” a text box results in the automatic display of a text entry cursor/tool.) Positioning may be based on an X-Y coordinate system, with each element having an entry in the listing 57a. For example, as shown in FIG. 5B, each of several text boxes may have a listing 66 defining a boundary/position of the text box in terms of X-Y coordinates and a size of the text box. The template listing 57a may also include an identifier and/or file name 68 of the simulated template, an identifier and/or file name 70 of the background image 54 for the template, and other fields/data/information relating to the simulated template 22 or sub-elements thereof. The templates may be configured in a number of different ways, depending on the desired characteristics of the templates 22 and the system 20 as implemented in any particular instance. For example, although FIG. 5B shows the template listing 57a as a program-like text file, other data formats may be used.

In a simulated template 22, the rendering data 56 specifies the appearance and location of the font/text 50 and graphic elements 52 with respect to the fixed art image 54. The rendering data 56 may be based solely on user layout, e.g., the rendering data is a function of user placement and formatting of text and graphic elements, with the user being free to manipulate these elements in an unrestricted manner. Additionally, certain background art images 54 and/or simulated templates 22 may be provided with linked rendering data (e.g., the rendering data is linked to the template or background image) that governs and restricts the placement of text and/or graphic elements with respect to the background image. For example, if a certain background image has fixed boxes/fields for the placement of text or graphics, designated areas for slogans, addresses, or the like, or other specially designated areas, the background image may have rendering data linked thereto that, for example, prevents a user from adding text outside the designated areas.

As noted, the public and client-specific art libraries 38a-38c are stored on the server module 28. The public library 38a includes one or more graphic elements 52, fixed art images 54, and pre-made templates 22, if available. Each fixed art image 54 is a static graphic representation suitable for use as the background for an advertisement for a particular type of business. An example of a background image 54 for a pizza restaurant is show in FIG. 4, which contains elements such as a pizza 64a, the Coliseum in Rome 64b, and various spaces 64c for text. This also encompasses “blank” or “white” backgrounds of a particular size and/or shape. The graphic elements 52 are standard drawings or pictures that have been found to have general applicability in advertisements for different types or categories of businesses. One example is an image or set of images associated with one or more credit card logos, as shown in FIG. 7B. The graphic elements 52 may be static/non-modifiable (see FIG. 7A), or they may be modifiable (see FIG. 7B). For the latter, the graphic elements 52 may include one or more sub-elements 74, e.g., each representing a graphic for a particular credit card. A user selects one or more of the sub-elements to display by way of, e.g., a drop down menu 76 or the like. The drop down menu or other selection functionality may be provided as part of the graphic element, and/or it may be implemented through the control module 42 or user interface 48. In addition to the graphic sub-elements 74, the image elements 52 may further include an identifier 78 and formatting information 80 for use by the user interface 48 in generating the drop down menu or otherwise.

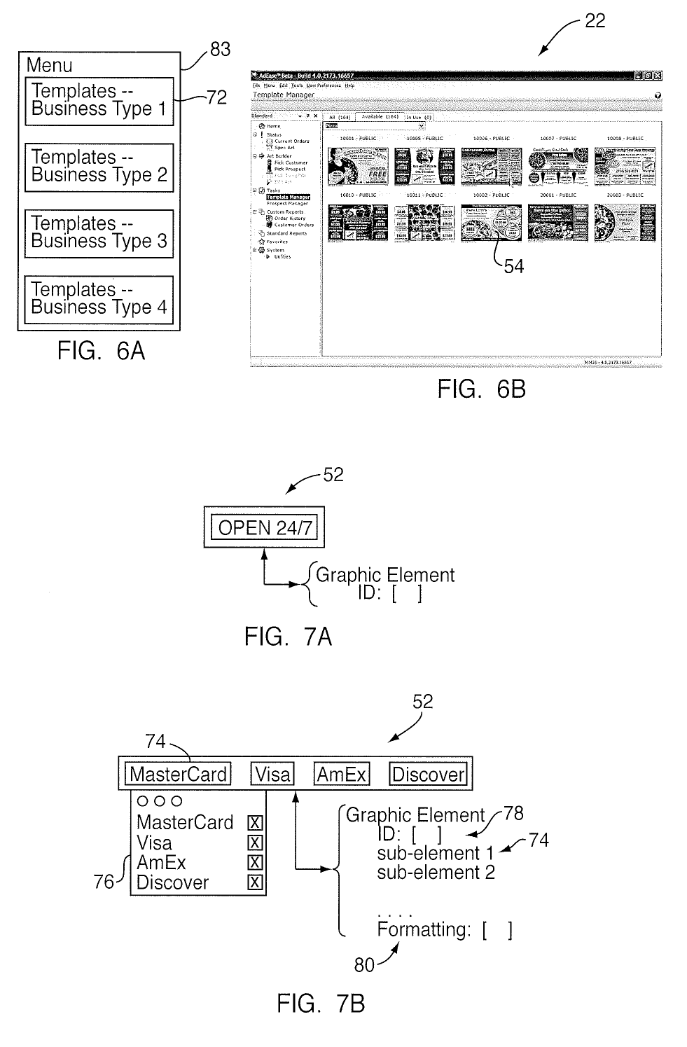

If pre-made simulated templates are made available to users, the public library 38a will contain a number of different categories of templates 72 for various types of businesses and/or prospective advertisers (see FIG. 6A), and a number of different pre-made templates 22 for each type of business (see FIG. 6B). If the system 20 is not provided with pre-made templates per se, related background images and graphic elements may be grouped together in a manner as shown in FIGS. 6A and 6B, for easy user access under one or more sub-menus. Alternatively, users may be provided with sample customized template images, wherein upon selecting a sample template image the user is presented with the separate elements of the template (e.g., background image and graphic elements) that the user may then combine, position, and format according to a desired custom layout.

The client-specific libraries 38b, 38c on the server module 28 are similar to the general or public library 38a, except that the templates 22, background images 54, and/or graphic elements 52 therein are customized for specific users. For example, if a user requires specific, non-generic advertisements, advertisements with specific background images, or customized graphic elements such as business logos, trademarks, or maps, these may be generated in an advance and/or ongoing manner using a standard graphics editor program. The customized elements are then saved on the server terminal 30 in association with the user's library 38b, 38c, as low-resolution files 82a for use in the template customization process (e.g., on the client module), and/or as high-resolution files 82b for future use in creating pre-press ready files 24 for generating printing plates for printing advertisements.

The client module 32 is a software program or suite of software programs running on the client terminal 34, which will typically be a standard computer (e.g., laptop or desktop computer) having a display/monitor 84 and standard hardware and/or software for accessing and communicating over the network 36. The client module 32 may be downloaded over the network, or it may be provided stored on portable storage media such as CD- or DVD-ROM's, in both cases for installation onto the client terminal 34 in a standard manner and possibly in conjunction and coordination with an operating system running on the client module, such as Microsoft® Windows XP. The client module 32 may be used directly by clients/advertisers, or it may be used by sales personnel for creating advertisements on behalf of and/or in consultation with clients/advertisers. The client module 32 includes the rendering engine 46, the user interface 48, and the synchronization module 62. In operation, a user accesses the client module 32 by way of the user interface 48. The user interface will typically be a graphical user interface; alternatively, the user interface could be a command line or text based interface, or the like. The user interface 48 includes a number of options, selections, menus, and/or commands for accessing the functionality of the user interface 48, as described below. Each user is provided with an instance of the client module software for running on the user's terminal.

For customizing a simulated template 22, a user accesses the client module 32 by way of the user interface 48. The user interface 48 provides several options for proceeding, possibly including “create new template,” “customize existing template,” and the like. Selecting the latter allows the user to load an existing customized template (e.g., a template based on an original layout or a customized pre-made template) from mass storage on the client terminal. To select a template for loading, the user may be provided with a listing of the templates stored on the client terminal, or the user may be shown a menu or selection of available templates 22 (FIG. 6B), e.g., shown as “thumbnail” or reduced-size images. Once a selected customized template 22 is loaded from storage into active terminal memory, the rendering engine 46 in conjunction with the user interface 48 translates the template listing 57a for WYSIWYG display 57b and modification by the user. For example, the rendering engine 46 may load the low-resolution background image 54 underlying the template 22 based on the graphic file ID 70 in the template listing 57a (FIG. 5B). The background image 54 is then displayed on the client terminal's monitor 84 (FIG. 4), in a virtual workspace, window, or the like. The rendering engine 46 and/or user interface 48 also translates the remainder of the template file or other listing 57a, e.g., graphic elements 52, entries relating to text boxes 66, and text content 50, into a graphical form 57b usable for modifying the simulated template. For example, as shown in FIG. 5A, various text box fields 64c will be presented superimposed on the background image 54, inside of which is displayed the text content 50. The user may modify the text content 50, or add or remove text, as appropriate for the type and format of advertisement desired. (Formatting options may be provided in a drop down menu, toolbar, or other text-formatting menu provided through the user interface 48; the available formatting options will typically be limited to those interpretable by the server module 28 for generating high-resolution equivalents.) The user interface 48 also provides functionality for a user to select, add, and possible modify graphic elements 52 to the customized template 22. An example of a displayed customized template 57b is shown in FIG. 8. As indicated, various advertising text has been added over the background image shown in FIG. 4.

Selecting the “create new template” option (or a similar function) allows a user to begin a new template customization. This may be done by individually selecting, placing, and formatting template elements, or by selecting and subsequently customizing a pre-made template as discussed above. In either case, the user interface 48 may generate a menu 83 of the categories of available pre-made templates 72 and/or template elements (FIG. 6A) and a subsequent menu or selection of available pre-made templates 22 and/or background images and graphic elements (FIG. 6B), shown as “thumbnail” or reduced-size images. Other menu formats are possible. In whatever particular manner the menu 82 is implemented, a user first selects the category of templates that is appropriate for the type of advertisement the user is interested in creating, e.g., based on business category. Upon selecting a business category, the user is presented with a number of pre-made templates in that category (FIG. 6B) and/or with a number of background images 54 and graphic elements 52 appropriate for the category. Subsequently, the user selects the pre-made template or background image 54 that most closely matches the advertisement that the user would like to create. The template and/or background image are then loaded into active memory for customization by the user, as described above.

Alternatively, upon selecting a “create new template” option, the user interface may generate an empty, initial workspace. From the initial workspace, the user may select from among various menu options for (i) selecting a pre-made template, if available, or (ii) selecting, placing, and formatting background images and graphic elements. For example, one menu option could allow the user to select a background image (arranged by category), and another could allow the user to select, place, and format text and graphic elements over the background image.

Typically, the client module 32 will have a complete library 63 of all the graphic elements, background images, and pre-made templates (if any) available in the system 20. This enables users to create customized templates without being connected to the network and server module. The library elements are low-resolution equivalents of the high-resolution elements 60 stored on the server terminal 30. Although lower in resolution, the library elements are of sufficient quality (e.g., XVGA quality) to provide an accurate representation of the high-resolution, pre-press ready file 24 and resultant printed advertisement when displayed on the client terminal display 84.

Although template elements and customized templates are stored locally on the client terminals, template elements and stored templates may also be obtained from the server module 28. For example, the server module 28 may contain an expanded library of template elements (e.g., background images and graphic elements), an expanded selection of pre-made templates, and/or client-specific customized templates in the libraries 38b, 38c. For obtaining files from the server terminal 30, the user directs the client module to access the server module 28 over the network 36. Once the server module 28 is accessed, the user selects the elements to be transferred through one or more menus or the like. If user-specific customized templates 22 are to be transferred, the client and server modules may implement security measures for restricting access to authorized users. Once an element is selected, the server terminal 30 transfers it over the network 36 to the client terminal 34, for local storage and access. As should be appreciated, by storing customized templates 22 on the server terminal, the user may access the customized templates on client terminals other than the one where the template was originally created and locally stored, i.e., the server terminal in this instance acts as a central data depository.

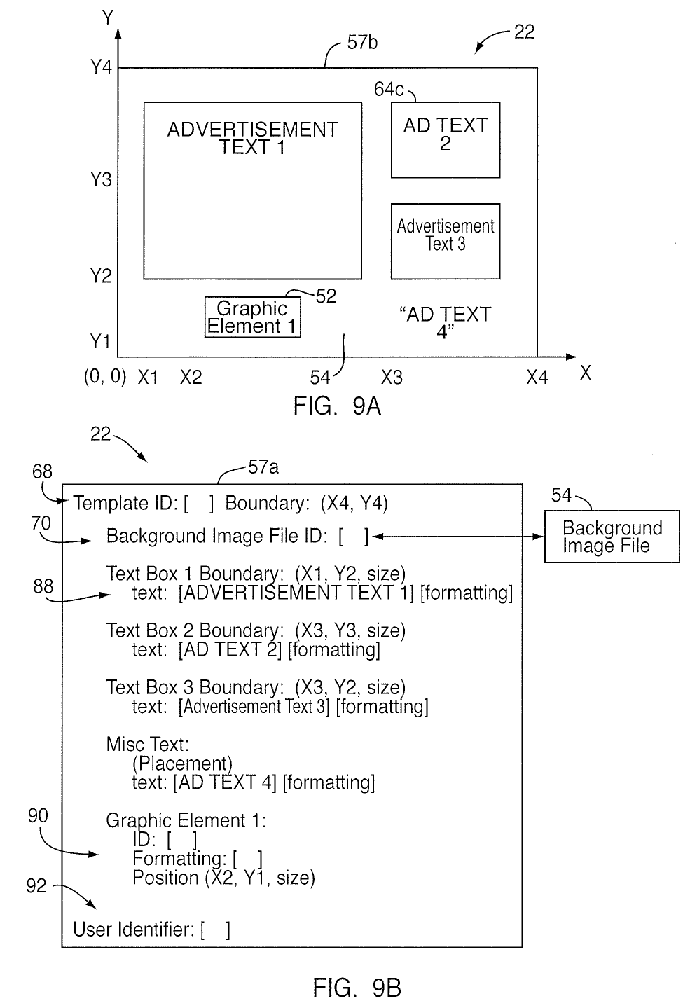

As a user customizes a simulated template 22 by adding text and image elements, it is displayed on the terminal display 84, as shown FIGS. 8 and 9A, in a WYSIWYG manner. As noted, the background image and graphic elements are of sufficient resolution to correspond to the actual appearance of the final, high-resolution printed advertisement. In addition, the template elements are displayed according to user formatting selections and/or the rendering data, meaning that they appear the same on the display 84 as in the printed advertisement. When a customized template is initially loaded, its elements (as listed in the template file 57a) are displayed by the rendering engine 46 according to the rendering data 56. As the template is customized, changes or modifications to the template are tracked and translated by the user interface 48 and/or rendering engine 46 as part of the template listing 57a, as shown in FIG. 9B. (FIG. 9B is a conceptual drawing provided as an example for explanatory purposes; the actual template listing, file, program, etc. may vary.) Like the pre-made template shown in FIG. 5B, the customized template listing 57a includes a template ID 68 and a background image ID or file 70. If designated text boxes 66 are used, the template listing 57a also includes information defining the text boxes 66. In addition, the customized template listing 57a includes the text strings 88 entered into the text boxes or elsewhere, along with formatting information, and a listing 90 for any graphic elements included in or added to the simulated template. The graphic element listing 90 may include an identifier of the graphic element added to the template plus formatting and position information relating to how the graphic element was modified (if at all) and where the graphic element was positioned with respect to the X-Y coordinate axis of the background image 54. (As should be appreciated, this information comprises part of the rendering data 56.)

Once completed, a customized template 22 may be saved on the client terminal 34 in temporary or permanent memory or other storage, for future use in creating additional customized templates, or in the event of a communication error. At the user's option, to proceed with generating a pre-press ready file 24, customization information 58 is transferred to the client terminal's synchronization module 62 for sending to the server terminal 30. As noted above, the customization information is information that at a minimum allows the server module to re-create or re-generate a simulated template 22 as created and/or customized by the user on the client terminal. Thus, the customization information 58 may simply comprise the customized template listing 57a, as shown in FIG. 9B. Alternatively, if pre-made templates or the like are used, since the pre-made templates exist on the server terminal, it may suffice to send information 58 identifying the template and relating to how the template was modified. (In other words, the server module would in effect automatically re-generate the customized template based on the ID of the pre-made template and the information as to how the user customized the pre-made template.) The information 58 transferred to the server terminal may also include a user identifier 92 for identifying the client, advertiser, or other end user in association with the customized template 22. The customization information 58 may be transferred to the server module 28 as a text or other file, as text strings, as command/encoded strings, or the like. For example, the customization information may be sent as an XML file.

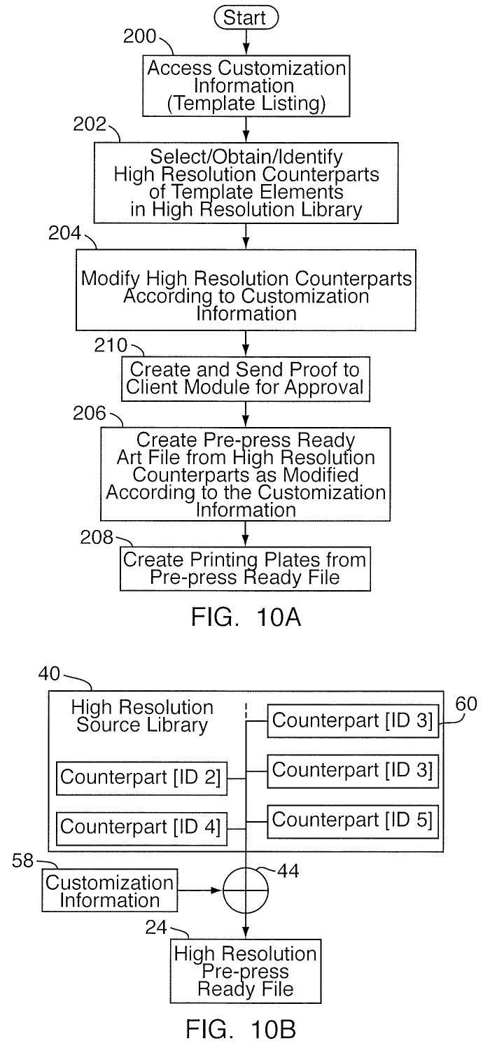

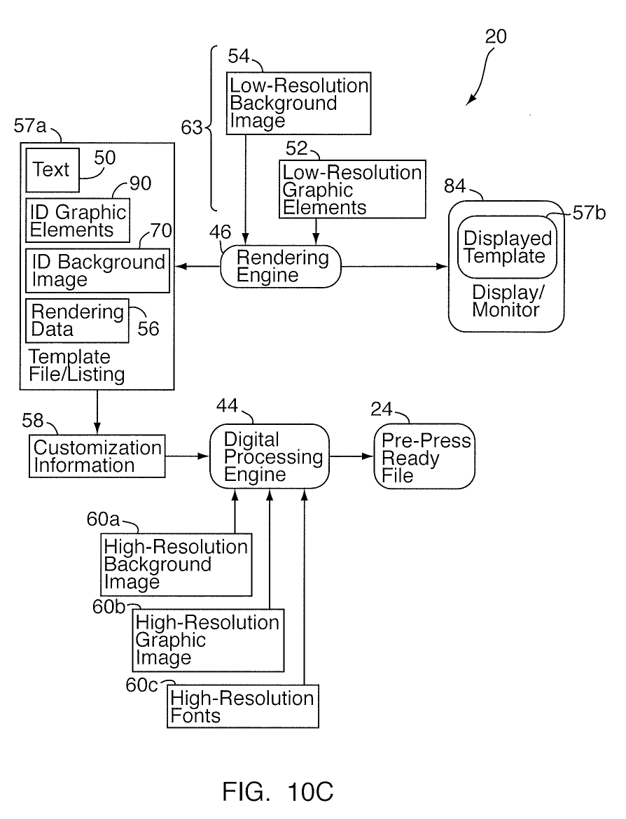

Once received by the synchronization module 62 in place on the server module 28, the customization information 58 may be stored in temporary or permanent memory or other storage, and in a client-specific library 38b, 38c, if applicable, according to the user identifier 92. The customization information may be stored for later access for producing the pre-press file 24 at a later date, if so instructed by the client terminal. At such a time as the customization information 58 is to be further processed, the digital processing engine portion 44 of the control module 42 automatically generates the pre-press ready file 24 according to the steps in FIG. 10A, as further shown graphically in FIG. 10B. (By “automatically,” it is meant that the server module 28 generates the file 24 without further input or involvement from end users.) The digital processing engine 44 interprets user selections, modifications, and preferences from the low-resolution simulated template 22 customized on the client terminal 32, according to the customization information (e.g., template listing and rendering data therein) received from the client terminal. As illustrated, at Step 200 the digital processing engine 44 accesses the customization information 58 stored in memory. At Step 202, the high-resolution counterparts 60 of the elements in the customized template are selected or accessed in the high-resolution source library 40. In other words, the digital processing engine 44 selects or obtains high-resolution equivalents of the elements in the customized template, such as the background image 54, graphic elements 52, and fonts. The selection is made based on the customization information 58 (e.g., template listing 57a), including the graphic element identifiers 90 and background image identifier 70. At Step 204, the high-resolution counterparts 60 are modified according to the customization information 58 (e.g., the rendering data 56 in the listing 57a), to produce a high-resolution graphic arts layout consisting of multiple high-resolution components. Then, at Step 206 the pre-press ready art file 24 is created from the high-resolution counterparts 60 as modified by the customization information 58. This is done in a standard manner according to whatever format is desired or required for the file 24. Thus, the result of the client-side simulation process is the server-side creation of press data, e.g., a pre-press ready graphic arts layout and/or pre-press ready art file 24, which can be used to create printing plates for commercial printing presses.

In effect, the digital processing engine 44 creates a high-resolution equivalent of the customized simulated template 22 as shown in FIGS. 8 and 9A, and in particular a high-resolution, production quality, print art file that is functionally “identical” in appearance to the low resolution ad simulation 22 that was viewed and modified on the client module 32. This relationship is again illustrated by way of FIG. 10C. As indicated, the template listing 57a is used as the basis for a low-resolution display of the template 57b on the client terminal 34. The rendering engine 46 reads the template listing, accesses a low-resolution background image 54 and graphic elements 52 from a low-resolution library 63 according to the ID's 70, 90 listed in the template, and displays these elements on the monitor 84 (along with text 50) according to the rendering data 56 that specifies placement and formatting. Similarly, the server module uses the template listing 57a (or other customization information 58) as the basis for generating the high-resolution, pre-press ready file 24. The digital processing engine 44 reads the template listing, accesses a high-resolution background image and graphic elements 60 according to the ID's 70, 90 listed in the template, and combines these elements, along with text 50, into the file 24, according to the rendering data 56.

After the pre-press ready file or other press data 24 is created, it may be stored in memory or other storage. Subsequently, the file 24 may be used to create printing plates for use with a commercial or other printing press 26 in a standard manner. As indicated in FIG. 10A at Step 210, the server module 28 may be configured to create and send to the client module a proof of the advertisement or other art image prior to creating the pre-press ready file. The proof may be displayed on the client terminal for approval by the end user, with acknowledgement of the approval being sent back to the server terminal to initiate generating of the pre-press ready file. The proof may be a low-resolution or high-resolution version of the customized simulated template, and it may be maintained solely on the server terminal, e.g., the user would access the server terminal through the user interface on the client module for viewing and approving the proof. Instead of creating the pre-press ready file after generation and approval of the proof, the proof may instead be derived from the pre-press ready file and/or created along with the pre-press ready file. If errors are found in the proof, the customized simulated template 22 (stored on the client terminal and/or the server terminal) may be accessed and re-modified as needed.

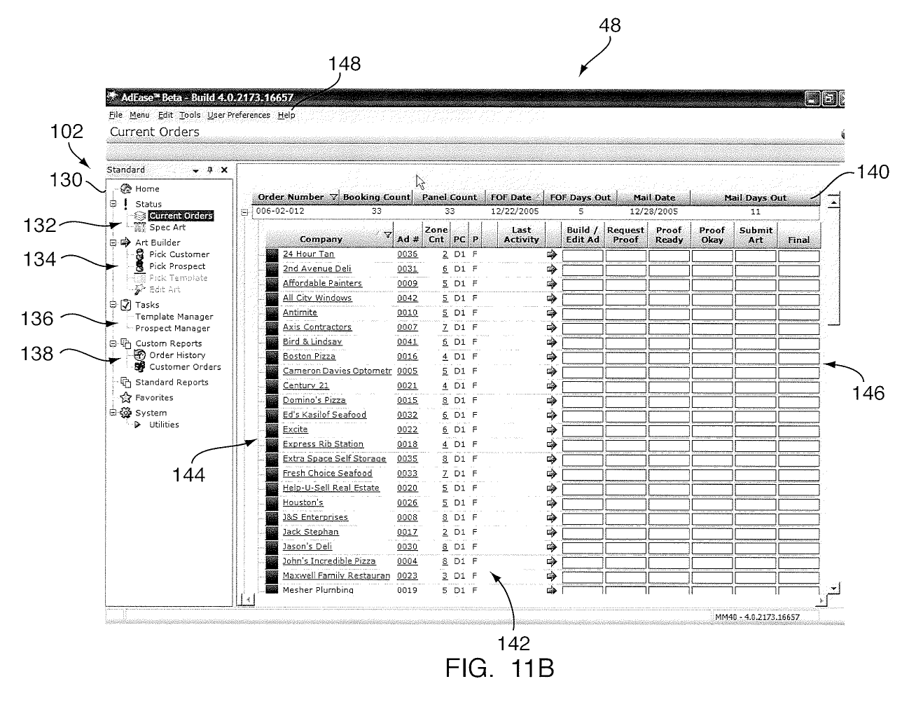

The system 20 may also include information and advertisement management functionality, for managing customer/client accounts, order history, and the like. For example, template customization can be carried out on a per-customer account basis, along with the ability to track and access the simulated templates that the customer has created/modified, the customer's order history, and the like. FIG. 11A shows one example of such an information management system 100; other menu systems and configurations are possible. As should be appreciated, the information management system 100 is integrated with the template customization functionality described above, and within the system 20. Also, the information management functionality may be implemented on the server module and/or the client module, e.g., some functions may be implemented on the server module and others on the client module, either on a stand-alone basis or working in conjunction or by way of access through the other module.

The information management system 100 includes a menu system 102 and at least one database 104. Some or all of the menu system 102 may be part of the user interface 48, and provides a means for users to easily and intuitively access the information stored on the database 104, including querying, searching, and report-generation functionality. Thus, the menu system may include selections or options for viewing orders, order status, and/or order history 106, a selection for accessing client information 108, a selection for generating reports 110, a selection for accessing templates 112, and a search function 114, among others. (The menu system may include sub-options or sub-menus, as applicable or desired, for each main entry; many different configurations are possible.) The database 104 may contain one or more records 116a, 116b for each client/customer, which includes information relating to the client's order history 118, contact information for the client 120 (e.g., name, address, client ID, and phone), and one or more files 122 containing stored copies of the templates the client has customized, client-specific pre-made templates and graphic elements, or the like. The client-related elements 118, 120, 122, etc. are not necessarily stored together or separately in one or more database records, but are merely linked thereto or together in a logical manner, e.g., through a common client identifier. The database 104 may also include information relating to a transaction history for all clients/advertisements 124, information relating to advertisement reservations and restrictions 126, and information 128 relating to the geographic distribution and/or relationship of clients, advertisement usage, or the like. Regarding the advertisement reservations and restrictions 126, the system 100 may be configured to restrict the usage of certain of the templates based on geographic restrictions, time restrictions, or both. For example, the system 100 may allow only one customer to use a particular template within a certain geographic region for a specified time period. This avoids the possibility or more than one business or other client or customer using the same template during the same time period, as might cause consumer confusion. The system 100 may allow users to reserve available/unrestricted templates, e.g., during the modification process, after the template is selected but before the final advertisement is printed. The list/record 126 is maintained for tracking which templates have been reserved for use, and for storing information as to which templates are restricted and in what manner. This information may be distribution to other parts of the system, as required for effectuating the restriction and reservation process/system.

FIG. 11B shows a more specific example of a portion of the menu system 102 and user interface 48, implemented for use with a Microsoft® Windows-based operating system. As indicated, the menu system 102 may include a menu “tree” 130 with a number of primary and secondary menu selections such as order status 132, an “art builder” option 134 for choosing and modifying templates as a function of customer account, management modules 136 for managing the templates, customer prospects, or the like, and options for generating reports 138. Once a particular selection or option is chosen in the menu tree 130, the tool or other function that corresponds to the menu choice is shown in the main window 140. FIG. 11B, for example, shows a current orders status chart/table 142, with listings organized by client/company 144. The listings may include an advertisement number, a geographic zone, and a status listing 146 of the various stages of the template selection and modification process, e.g., “Build/Edit Ad”→“Request Proof”→“Proof Ready”→“Proof Okay”→“Submit Art”→“Final”. The status listing 146 may be passive in nature, reflecting information provided by the client module and/or server module, and/or it may be used as an interface for a user to inform the system that certain steps have been completed. For example, upon approving of a template proof, the user might enter a checkmark into the box under “Proof Okay” (in the row for the appropriate client/customer), which is then submitted to the server module for informing the server module that the proof has been approved. The server module would then prepare the pre-press ready art file, and send an indication of such back to the client module, which would place a checkmark in the box under “Final,” for informing the user that the template process has been completed. The menu system 102 may also include one or more drop-down menus 148 providing further user options. The type of drop-down menu provided may vary depending on the selection/option chosen in the menu tree.

In another embodiment, the information management system 100 is integrated with accounting software and/or “e-commerce” functionality. For example, the system 100 may be configured for integration with Intuit Inc.'s QuickBooks® business financial software, for use in processing and tracking online or other payments, tracking order progress and history, and the like.

With reference to FIG. 12, in another embodiment of the present invention the client module 32 and server module 28 are integrated together into a unified, Internet-accessible system 150. The system 150 includes one or more elements or portions of the system 20 (possibly including portions of the client module 32, the server module 28, and/or the information management sub-system 100), all housed on a server terminal 152. The server terminal 152 is accessible from a client terminal 154 over the Internet 36 by way of a website 156 maintained on the server 152. The website 156 and functionality thereof (e.g., the template customization functions described above) may be implemented in a standard manner such as through one or more html-based programs. The website 156 would be accessed in a standard by way of a standard network browser program running on the client terminal, such as Microsoft® Internet Explorer, which is to say that data for reproducing website functionality would be transferred from the server to the client for re-creation and display on the client terminal, in a standard manner. Sales personnel and/or advertiser or client end users would access the website for selecting and modifying templates and creating the pre-press ready art files. For such a purpose, the server terminal would likely further include security and account establishment functionality. Such a configuration would obviate the need to provide and install the client module on the client terminal, but would necessitate connection to the Internet for selecting and modifying templates. (As noted above, depending on the particular configuration of the system 20 as implemented, it will typically be possible to modify templates on the client module while disconnected from the network and server, with the modification/customization information being sent to the server module through the synchronization module when a network connection is next established.)

Since certain changes may be made in the above-described template-based art creation and information management system for advertisements, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A system for creating art images comprising:
a user interface configured for display and user customization of a simulated template, said template comprising text, at least one advertisement image element, and rendering data relating to the placement and formatting of said text with respect to the at least one advertisement image element; and
a control module in communication with the user interface, wherein the control module is configured to automatically generate press data based on the simulated template, said press data being adapted for use in creating a printing plate for printing art images corresponding to the simulated template.

2. The system of claim 1 wherein the at least one advertisement image element comprises an advertisement background image and at least one graphic element for overlay of the background image.

3. The system of claim 2 wherein the user interface displays the simulated template at a first resolution, and at least a portion of the press data is at a second resolution higher than the first resolution for commercial printing.

4. The system of claim 3 wherein the displayed simulated template corresponds substantially exactly to the art images printed using the printing plate.

5. The system of claim 4 wherein the user interface is a graphical user interface configured for user manipulation of the background image, text, and/or graphic element as displayed, said user manipulation being recorded in the rendering data.

6. The system of claim 3 further comprising:
a client module; and
a server module remote from the client module, said client module and said server module being configured for communicating with one another over a network, wherein the user interface is implemented as part of the client module and the control module is implemented as part of the server module.

7. The system of claim 6 wherein:
the simulated template relates to an advertisement art image;
the client module further comprises a client library including a plurality of advertisement background art images and graphic elements for a plurality of business categories, said art images and graphic elements being at the first resolution, wherein for displaying the simulated template the background image and any graphic elements of the simulated template are retrieved from the client library; and
the server module further comprises a server library including a plurality of advertisement background art images and graphic elements, said server library art images and graphic elements being at the second resolution and corresponding to the client library art images and graphic elements, wherein for generating the press data the background image and any graphic elements of the simulated template are retrieved from the server library and formatted according to the rendering data.

8. The system of claim 2 wherein the simulated template comprises a template listing including (i) identifiers associated with the simulated template background image and graphic elements, (ii) the rendering data, and (iii) a user identifier.

9. A system for creating printed advertisements comprising:
a client module having a user interface, a client library, and an electronic advertising template, said client library including a plurality of advertisement image elements, and said template including (i) at least one identifier associated with at least one of said advertisement elements, (ii) text content, and (iii) rendering data specifying formatting and/or placement of said text content with respect to the at least one advertisement element identified in the template;
wherein the user interface is configured to display the text content and the at least one advertisement element identified in the template, as retrieved from the client library according to the at least one identifier, based on the rendering data; and
wherein the user interface is a graphical user interface including customization functionality for user customization of the displayed text content and at least one advertisement element.

10. The system of claim 9 further comprising:
a server module having a server library including a plurality of advertisement image elements corresponding to the client library advertisement image elements, said server library advertisement image elements each being a resolution greater than the resolutions of the client library advertisement image elements;
wherein the server module is configured to generate press data based at least in part on customization information received from the client module, said customization information relating to the electronic advertising template; and
wherein the press data is configured for use in creating a printing plate corresponding to the electronic advertising template as displayed.

11. The system of claim 10 wherein the press data includes data relating to the text content and the at least one advertisement element identified in the template, as retrieved from the server library according to the at least one identifier, said text content and/or at least one advertisement element being formatted and/or placed according to the rendering data.

12. The system of claim 11 wherein the advertisement image elements comprise fixed advertisement background images and advertisement graphic elements for placement over the background images.

13. A system for creating printed advertisements comprising:
a client module having a graphical user interface for display and user customization of an electronic advertising template, said template including (i) a plurality of template elements and (ii) rendering data specifying formatting and/or placement of said template elements, wherein the template elements are displayed at least one first resolution and according to the rendering data; and
a server module remote from the client module and configured for communication therewith, wherein the server module is configured to generate press data based at least in part on customization information received from the client module, said customization information relating to the electronic advertising template;
wherein the press data is configured for use in creating a printing plate corresponding to the template elements as displayed by the client module, at least one of the press data and the printing plate having at least one second resolution higher than the at least one first resolution.

14. The system of claim 13 wherein the customization information comprises a listing of the electronic advertising template.

15. The system of claim 14 wherein:
the template elements include (i) text content, (ii) an advertisement background image, and (iii) at least one advertisement graphic element; and
the rendering data specifies the placement of the text content and at least one advertisement graphic element with respect to the background image.

16. The system of claim 15 wherein:
for display of the template by the client module, the advertisement background image and at least one advertisement graphic element are accessed from a client library containing a plurality of stored background images and graphic elements at the at least one first resolution; and
for generation of the press data by the server module, the advertisement background image and at least one advertisement graphic element are accessed from a server library containing a plurality of stored background images and graphic elements corresponding to those in the client library but at the at least one second resolution.

17. A system for creating advertisements comprising:
a server module configured to generate press data based on received customization data relating to the layout of a simulated advertising template displayed at a first resolution;
wherein the press data is adapted for use in creating a printing plate for printing art images corresponding to the displayed simulated advertising template and having a second resolution greater than the first resolution.

18. The system of claim 17 further comprising:
a client module for displaying the simulated advertising template, said client module including a graphical user interface for user manipulation of the displayed simulated advertising template, wherein the client module generates the customization data based on said user manipulation.

19. The system of claim 18 wherein:
the template includes text and at least one advertisement image element, said at least one template advertisement image element being accessed from a client library portion of the client module for display by the client module, said client library having a plurality of advertisement image elements at the first resolution; and
the server module includes a server module library having a plurality of advertisement image elements corresponding to the advertisement image elements of the client library, said server library advertisement image elements being at the second resolution, wherein the press data includes the at least one template advertisement image element as accessed from the server module library.

20. A method for preparing printed art images, said method comprising the steps of:
displaying a simulated template at a first resolution;
generating customization data based on graphical user manipulation of the displayed simulated template; and
generating press data based on the customization data, wherein the press data is adapted for use in printing art images corresponding to the displayed simulated template, at least one of the press data and the printed art images having a second resolution greater than the first resolution.

21. The method of claim 20 wherein:
the displayed simulated template includes at least one image element, said at least one image element being accessed from a first library including a plurality of image elements each at a resolution lower than the second resolution; and
the press data includes at least one press data image element each corresponding to a respective one of the at least one displayed simulated template image element, said at least one press data image element being accessed from a second library including a plurality of image elements each at the second resolution and corresponding to the image elements of the first library.

22. The method of claim 20 further comprising:
generating a printing plate from the press data, said printing plate being configured for use in printing the art images corresponding to the displayed simulated template.
